(19) United States
(12) Patent Application Publication
(10) Pub. No.: US 2020/0129789 A1
(43) Pub. Date: Apr. 30, 2020

(54) FALL PROTECTION SAFETY APPARATUS

(71) Applicant: Highbury Concrete, Inc., Maspeth, NY (US)

(72) Inventors: Thomas Gorman, Orangeburg, NY (US); Thomas Fogarty, Blauevelt, NY (US)

(21) Appl. No.: 16/592,064

(22) Filed: Oct. 3, 2019

Related U.S. Application Data
(60) Provisional application No. 62/741,700, filed on Oct. 5, 2018.

(51) Int. Cl. A62B 35/00

(52) U.S. Cl. CPC A62B 35/0037; A62B 35/0056

(57) ABSTRACT

A fall protection safety apparatus is provided for use with fall protection assemblies such as those including a harness and tethering element (such as a cable, Lanyard, or strap) for attaching a person occupying the upper level of a multiple level structure. The safety apparatus includes a base post connected to a base level concrete slab and a mast connected to the base post, extending upward through the upper working level and providing an attachment mechanism for connecting the tethering element thereto. The safety apparatus provides a strong and stationary attachment point for connecting the person occupying the upper working level, regardless of whether a suitable stationary feature exists on the structure itself or is close enough to the area where the person must work. The safety apparatus may be positioned as desired on the base and working levels and even relocated to different base and working levels.

### CROSS-REFERENCE TO RELATED APPLICATIONS

The present application claims the benefit of U.S. Provisional Application No. 62/741,700 filed on Oct. 5, 2018, the entire disclosure of which is hereby incorporated by reference herein.

### FIELD OF THE INVENTION

The present invention relates generally to a safety apparatus which provides or enhances fall protection for persons working on multiple level structures. More particularly, the present invention relates to a safety apparatus to which such at-risk persons may be securely tethered, such as with conventional fall protection systems, and which may be positioned as desired and even relocated.

### BACKGROUND OF THE INVENTION

During the construction, renovation, or other work performed on multiple level structures, such as multi-floor buildings and parking decks, persons working on any level above the first level of the structure are at significant risk of falling and being seriously, or even fatally, injured. This risk is commonly mitigated by tethering such persons, using a cable, lanyard, etc., to the structure. More specifically, persons in danger of falling from the upper level of a structure often wear a safety belt or harness, to which one end of a cable or lanyard is attached using a connector (such as a snap or latch hook and D-ring system). The other end of the cable or lanyard is attached, often also using a connector, or a pulley system, to some part of the structure, such as a beam, post, or other stationary feature. Such fall protection systems are often required to meet standards and specifications set by industry or government authorities, including but not limited to the Occupational Safety and Health Administration of the United States Department of Labor.

Sometimes there is no suitable stationary feature which is available or close enough to the area where the person must work to which a fall protection system can be connected as described above. Even if there is a stationary feature, it may not be strong enough to support the weight of the person and his or her equipment in the event of a fall, or it may be susceptible to an unacceptable degree of damage in the event of such a fall. A safety apparatus has been developed which addresses the foregoing issues by providing a strong stationary point of attachment for persons at risk of falling from an upper level of a multiple level structure, and which may be positioned as desired and even relocated.

### SUMMARY OF THE INVENTION

The present invention relates to a fall protection safety apparatus for use with fall protection assemblies such as those including a harness and tethering element (such as a cable, Lanyard, or strap) for attaching a person occupying the upper level of a multiple level structure. The safety apparatus includes a base post connected to a base level concrete slab and a plurality of stabilizing struts connected to both the base post and the concrete slab. The safety apparatus further includes a mast connected to the base post, extending upward through an upper working level and providing an attachment mechanism for connecting the tethering element thereto. The safety apparatus provides a strong and stationary attachment point for connecting the person occupying the upper working level, regardless of whether a suitable stationary feature exists on the structure itself or is close enough to the area where the person must work. The safety apparatus may be positioned as desired on the base and working levels and even relocated to different base and working levels.

### BRIEF DESCRIPTION OF THE DRAWINGS

The present invention will be further explained with reference to the attached drawings, wherein like structures are referred to by like numerals and/or letters throughout the several views. The drawings shown are not necessarily to scale, with emphasis instead generally being placed upon illustrating the principles of the present invention.

FIG. 1 is an elevational view of an embodiment of a safety apparatus in accordance with the present invention and shown in use in its assembled state;

FIG. 2 is a top plan view of the safety apparatus of FIG. 1, without the adjustable mast, and looking down in the direction of the arrow A, showing the connection and orientation of the base post and braces with one another and a concrete slab;

FIG. 3 is an enlarged partial cross-sectional side view of the post-slab connection (B) shown in FIG. 1, between the base post and the concrete slab;

FIG. 4 is an enlarged top plan view of the post-slab connection (B) shown in FIG. 3;

FIG. 5 is an enlarged partial cross-sectional side view of one of the brace-slab connections (C) shown in FIG. 1, between one of the braces and the concrete slab;

FIG. 6 is a perspective view of a bracket suitable for use in the brace-slab connections (C) shown in FIG. 5;

FIG. 7 is an enlarged elevational front view of the second end of the base post and braces connected thereto (see section D shown in FIG. 1), in which three of the post-brace connections are visible;

FIG. 8 is an enlarged top plan view of the second end of the base post and braces connected thereto (see section D shown in FIG. 1), in which all four of the post-brace connections are visible;

FIG. 9A is an elevational side view of the second end of a brace showing a spacer plate and a hole through both the spacer plate and the second end of the brace;

FIG. 9B is a cross-sectional view of the brace shown in FIG. 9A, taken along line E-E and looking in the direction of the arrows;

FIG. 10 is an elevational front view of the mast and second end of the base post;

FIG. 11 is an enlarged front view of the second end of the mast showing a connector for attaching a safety harness to the safety apparatus (see section G of FIG. 10); and

FIG. 12 is an enlarged front view of the first end of the mast and the mast-post connection (H) shown in FIG. 10.

### DETAILED DESCRIPTION OF THE INVENTION

Detailed embodiments of the present invention are disclosed herein. It should be understood that the disclosed embodiments are merely illustrative of the invention which may be embodied in various forms. In addition, each of the examples given in connection with the various embodiments of the invention is intended to be illustrative, and not restrictive. Further, the figures are not necessarily to scale, and some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as examples for teaching one skilled in the art to variously employ the present invention.

The safety apparatus described and contemplated herein provides, or enhances, fall protection for persons performing work on an upper working level (i.e., other than the bottommost level) of a multiple level structure. For purposes of the following discussion, the upper level of a structure occupied by the person is the “working level” and the level immediately below the working level is the “base level.” Thus, the working and base levels are adjacent levels of the structure and are defined relative to where the person is located. As work progresses, when the person moves on to another upper level to continue work, that next upper level becomes the “working level” and the level immediately below this next working level becomes the “base level” (which may or may not be the previous working level).

The safety apparatus provides a strong and stationary attachment point for connecting a person working on an upper level of a multiple level structure and wearing a fall protection system (such as a belt and cable assembly, or a harness and lanyard assembly, etc.), regardless of whether a suitable stationary feature exists on the structure itself or is close enough to the area where the person must work. The safety apparatus may be positioned as desired on the base and working levels and even relocated to different base and working levels.

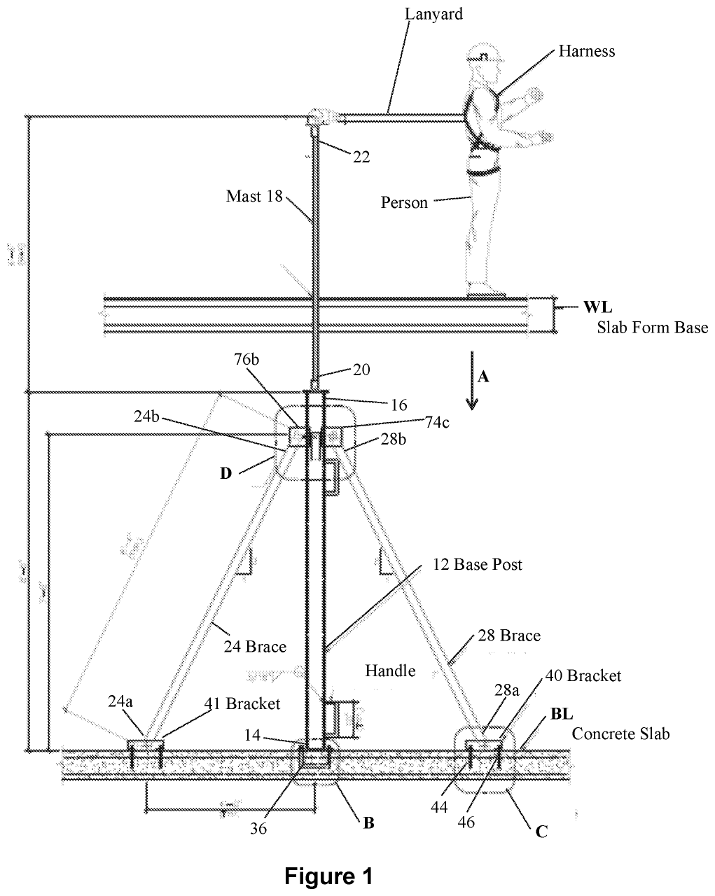

The components of an exemplary embodiment of the safety apparatus and the manner of their assembly will now be described in detail with reference to FIGS. 1-12. Thereafter, the use of the safety apparatus will be described in detail with reference primarily to FIG. 1. An elevational view of an embodiment of a safety apparatus 10 is provided in FIG. 1 in its assembled state and in use by a Person occupying a working level (WL) of a multiple level structure (not shown in its entirety), which also has a base level (BL) located immediately below the working level (WL). Such a Person may be wearing a fall protection system such as, without limitation, one that incudes a Harness and a Lanyard for tethering the Person to the structure. Typically, the base and working levels (BL, WL) are each individually formed and defined, at least in part, by a concrete slab, as is conventional and understood by persons of ordinary skill in the relevant art. It should be noted that the multiple level structure and its levels, including the base and working levels (BL, WL), the Person occupying the working level (BL) and the fall protection system which may be used by such Person, are environmental elements which use or are used with, but are not part of, the safety apparatus described and contemplated herein as the invention.

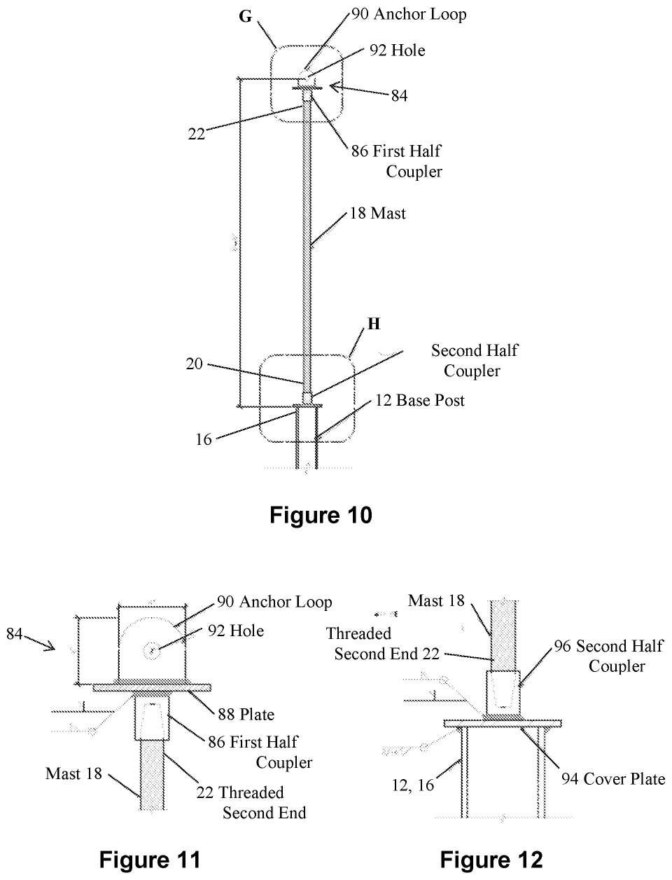

More particularly, as shown in FIG. 1, the safety apparatus 10 includes a base post 12 having a first end 14 and a second end 16, and a mast 18 also having a first end 20 and a second end 22. As will be described in further detail below, when the safety apparatus 10 is assembled and installed, the base post 12 is connected by its first end 14 to the base level (BL) of the multiple level structure to form the post-slab connection (B) and the mast 18 is connected by its first end 20 to the second end 16 of the base post 12 to form the post-mast connection (H) (see FIGS. 10 and 12, discussed below).

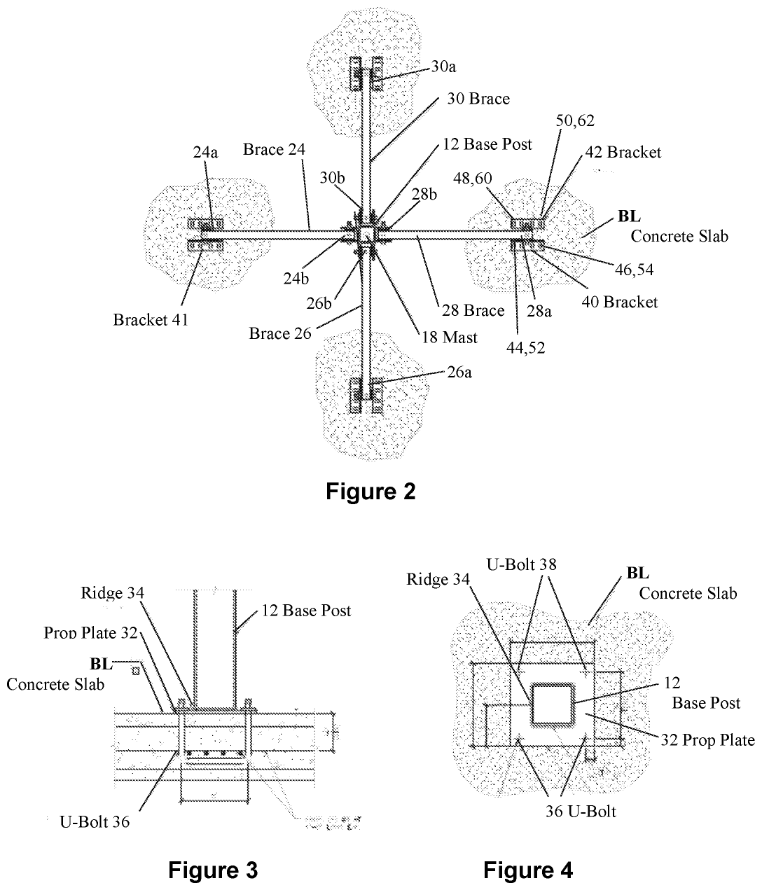

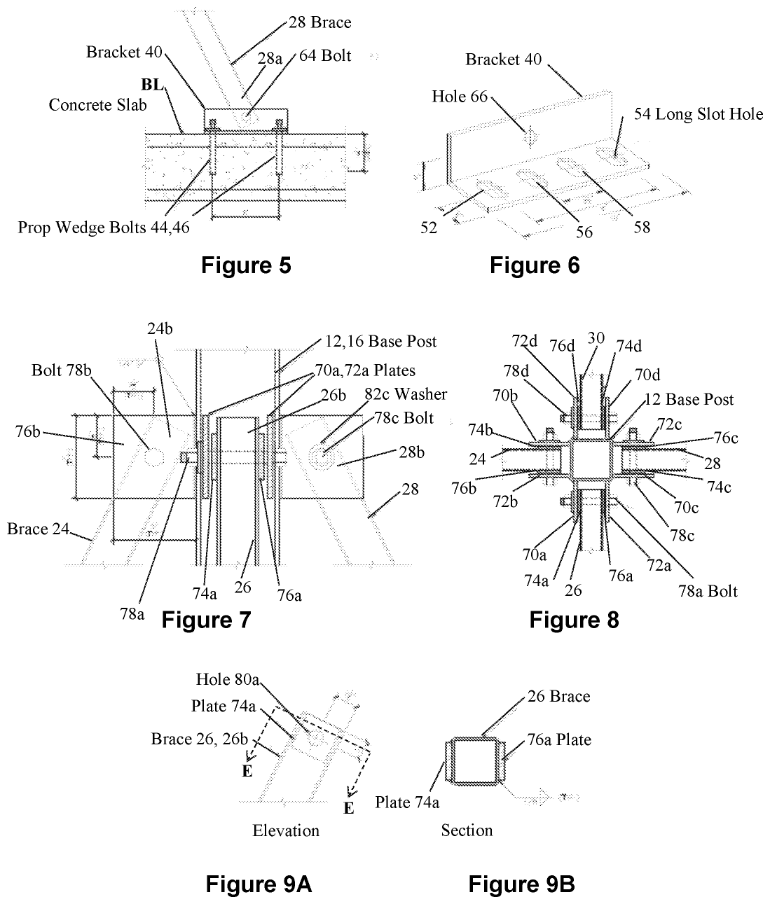

With reference to both FIGS. 1 and 2, the safety apparatus 10 also includes a plurality of braces 24, 26, 28, 30, only two of which 24, 28 are visible in FIG. 1. The top plan view of FIG. 2 shows the safety apparatus 10, without the mast 18 and looking down in the direction of the arrow A, so that the connection and orientation of the base post 12 and braces 24, 26, 28, 30 with one another and the base level (BL) is more clearly visible. More particularly, each of the braces 24, 26, 28, 30 has a first end 24a, 26a, 28a, 30a and a second end 24b, 26b, 28b, 30b, respectively. As shown in FIGS. 1 and 2 and described in further detail below, each of the braces 24, 26, 28, 30 is connected at its first end 24a, 26a, 28a, 30a to the base level (BL) to form a plurality of brace-slab connections (C) (see FIGS. 1 and 5), and at its second end 24b, 26b, 28b, 30b, respectively, to the base post 12 proximate its second end 16 to form a plurality of post-brace connections (see section D of FIG. 1 and FIG. 7).

While the exemplary embodiment of the safety apparatus 10 described herein and shown in FIGS. 1-12 includes four braces 24, 26, 28, 30, the safety apparatus 10 may have as few as three, or more than four, braces, as desired. Furthermore, while each of the base post 12 and braces 24, 26, 28, 30 is described herein and shown in FIGS. 1-12 as having a hollow square cross-section, one or more of such components may have a different cross-sectional shape such as, without limitation, triangular, rectilinear, circular, oval, etc. For example, as an alternative embodiment of the safety apparatus 10 (not shown), the base post 12 could have a hollow triangular cross-section and three braces connected thereto.

With reference now to FIGS. 3 and 4, FIG. 3 provides an enlarged partial cross-sectional side view of the post-slab connection (B) (see also FIG. 1), between the first end 14 of the base post 12 and the concrete slab of the base level (BL). FIG. 4 is an enlarged top plan view of the post-slab connection (B). As shown in FIGS. 3 and 4, the base post 12 includes a prop plate 32, which is formed integrally with, or permanently affixed to, the first end 14 of the base post 12, for example by welding or other suitable method such as are known by persons of ordinary skill. The prop plate 32 includes a ridge 34 surrounding first end 14 of the base post 12 and a plurality of holes therethrough (not shown per se). The base post 12 is connected to the base level (BL) using one or more fasteners, such as the U-bolts 36, 38 shown most clearly in FIGS. 1 and 3, or with individual straight bolts (not shown) or other suitable fasteners, extending through the prop plate 32 (i.e., through the holes) and into the concrete slab of the base level (BL). Obviously, in embodiments where U-bolts 36, 38 are used for the post-slab connection (B), they must be placed in the base level (BL) when the concrete slab is poured, but before it sets, at positions where it is desired to install the safety apparatus 10 and connect the base post 12 using the prop plate 32.

The brace-slab connections (C) between the first end 24a, 26a, 28a, 30a of each brace 24, 26, 28, 30, respectively, and the base level (BL) will now be described in detail with reference to FIGS. 1, 2, 5 and 6. While all four such connections are shown in FIG. 2, FIG. 5 provides an enlarged partial cross-sectional side view of the exemplary brace-slab connection (C) shown and labeled in FIG. 1. As shown, the first end 28a of the brace 28 is connected to the base level (BL) using a pair of brackets 40, 42 and several prop wedge bolts 44, 46, 48, 50. More particularly, the brackets 40, 42 are secured to the base level (BL) by inserting the prop wedge bolts 44, 46, 48, 50 through holes 52, 54, 60, 62 provided in the brackets 40, 42, respectively, for this purpose. The first end 28a of the brace 28 is positioned between the brackets 40, 42 and connected thereto with a bolt 64 through holes (not shown per se) provided through the first end 28a of the brace 28 and pivot holes provided in the brackets 40, 42. It is noted that each of FIGS. 1 and 2 also shows one of the brackets 41 which form the brace-slab connection between the left side brace 24 and the base level (BL).

FIG. 6 provides a perspective view of a typical bracket 40 suitable for use to connect the braces 24, 26, 28, 30 to the base level (BL) as described above. The plurality of holes 52, 54, 56, 58 in the bracket 40 for receiving one or more prop wedge bolts (e.g., 44, 46) and a pivot hole 66 which receives the bolt 64, which also extends through the first end 28a of the brace 28, are most clearly visible in FIG. 60.

With reference now to FIGS. 1, 7 and 8, the post-brace connections between the second end 16 of the base post 12 and the second ends 24b, 26b, 28b, 30b of each of the braces 24, 26, 28, 30, respectively, will now be described in further detail. FIG. 7 provides an enlarged elevational front view of Section D of FIG. 1 showing three of the post-brace connections in which the second ends 24b, 26b, 28b of each of the corresponding braces 24, 26, 28, respectively, are connected to the base post 12 proximate its second end 16. All four post-brace connections are more clearly visible in FIG. 8 which provides an enlarged top plan view of section D shown in FIG. 1 and of the post-brace connections shown in FIG. 7. In the front-facing post-base connection of FIGS. 1 and 7, two connection plates 70a, 72a extend in parallel with one another from the base post 12 proximate the second end 16 thereof. The corresponding brace 26 includes spacer plates 74a, 76a affixed on either side of its second end 26b such that the second end 26a and spacer plates 74a, 76a fit closely in between the two connection plates 70a, 72a but with sufficient clearance to form a pivotable post-brace connection between the base post 12 and brace 26 when a bolt 78a is inserted through aligned holes (not shown) provided through each of the connection plates 70a, 72a, the second end 26b of the brace 26, and the spacer plates 74a, 76a. (Optionally, a washer 82c may also be used with the bolt 78c to form the post-brace connection between the base post 12 and brace 28, see FIG. 7.) As shown in FIGS. 1, 7 and 8, the remaining three post-brace connections are formed by analogous elements which are similarly labeled to facilitate understanding of this exemplary embodiment of the safety apparatus 10.

FIGS. 9A and 9B are provided to clarify details of the structure of the second end 24a, 26b, 28c, 30d of each brace 24, 26, 28, 30, respectively. FIG. 9A shows an elevational side view of the second end 26b of one of the braces 26, with the spacer plate 74a affixed thereto and the hole 80a through both the spacer plate 74a and the second end 26b of the brace 26. FIG. 9B is the cross-sectional view of the brace 26 shown in FIG. 9A, taken along line E-E and looking in the direction of the arrows, so that each of the spacer plates 74a, 76a is visible affixed to opposite surfaces of the second end 26a of the brace 26.

Next the mast 18 and attachment mechanism 84 for connecting the tethering element of a fall protection system worn by a Person will be described in further detail with reference to FIGS. 1, 10, 11 and 12. With reference back to FIG. 1, as previously explained, when a Person occupies the upper working level (WL) of a multiple level structure, he or she will often wear a fall protection assembly including a belt or Harness and a tethering element, i.e., a flexible, elongate cord- or strap-like feature (e.g., cable, Lanyard, rope, cord, twine, strap) for attaching the Person to a stationary feature of the structure. The safety apparatus 10 of the present invention provides an alternative stationary feature to which the tethering element may be connected to provide a stronger and more versatile anchor for connecting the tethering element. As shown in FIG. 1, the mast 18 is connected at its first end to the second end 16 of the base post 12, while the mast 18 itself extends through an opening provided in the concrete slab of the working level (WL) and has an attachment mechanism 84 affixed to its second end 22 which is positioned at a predetermined height above the working level (WL).

FIG. 11 provides an enlarged front view of section G of FIG. 10 to show an exemplary attachment mechanism 84 which includes a first half coupler 86 adapted to securely receive the threaded second end 22 of the mast therein. The first half coupler 86 has a plate 88 affixed thereto and an anchor loop 88 is affixed to the plate 88. The anchor loop 90 has a hole 92 to receive the tethering element, such as a Lanyard or cable, of a fall protection assembly (see, e.g., FIG. 1). The attachment mechanism 84 and its components described herein and shown in the accompanying figures are but one exemplary embodiment suitable for accomplishing the purpose set forth herein. It is well within the ability of persons of ordinary skill in the art to understand and devise alternative attachment mechanisms for attaching the tethering elements of fall protection assemblies in accordance with the present invention as described herein.

FIG. 12 provides an enlarged front view of the post-mast connection (H), shown and labeled in FIG. 10, between the base post 12 and the mast 18 of the safety apparatus 10. More particularly, a cover plate 94 is affixed to the second end 16 of the base post 12 and a second half coupler 96 is affixed to the cover plate 94. The second half coupler 96 is adapted to securely receive therein the threaded first end 20 of the mast 18.

As previously explained hereinabove, the safety apparatus 10 may be located at any desired position on the base and working levels (BL, WL) and is detachable and, therefore, moveable to another such position. Additionally, the safety apparatus 10 may be detached and reassembled and connected to different base and working levels (BL, WL) as the person moves from one working level (WL) to the next, so as to be conveniently positioned for attaching the tethering element of a fall protection assembly including a belt or harness, thereby providing additional fall protection as well as versatility with respect to the placement and re-use of the safety assembly 10.

It will be understood that the embodiments of the present invention described hereinabove are merely exemplary and that a person skilled in the art may make variations and modifications without departing from the spirit and scope of the invention. All such variations and modifications are intended to be included within the scope of the present invention.

1. A safety apparatus which provides or enhances fall protection for a worker occupying a working level (WL) of a multiple level structure which also has a base level (BL) which is immediately below the working level (WL), the safety apparatus comprising:
a base post 12 having:
a first base post end 14 for connecting to the base level (BL) of the multiple level structure to form a post-slab connection (B), and
a second base post end 16 opposite the first base post end 14; and
a mast 18 connected to the base post 12 and extending through an opening through the working level (WL) of the multiple level structure, the mast having:
a first mast end 20 which is connected to the second base post end 16 to form a post-mast connection (H) positioned between the base level (BL) and the working level (WL), and
a second mast end 22 opposite the first mast end 20 and positioned above the working level (WL);
a plurality of braces (24, 26, 28, 30), each of which has:
a first end (24a, 26a, 28a, 30a) for connecting each respective brace (24, 26, 28, 30) to the base level (BL) of the multiple level structure to form a plurality of brace-slab connections (C), respectively, and
a second end (24b, 26b, 28b, 30b) opposite its respective first end (24a, 26a, 28a, 30a), the second end of each of the plurality of braces (245, 26, 28, 30) being connected to the base post 12, proximate the second base post end 16, to form a plurality of post-brace connections (D); and
an attachment mechanism 84 affixed to, or formed integrally with, the second mast end 22 for tethering the worker to the safety apparatus with a tethering element.

2. The safety apparatus of claim 1, wherein the base post 12 comprises a square cross-section and the plurality of braces (24, 26, 28, 30) comprises four braces.

3. The safety apparatus of claim 1, further comprising a connector 32 having a plurality of holes therethrough and being permanently affixed, or formed integrally with, the first base post end 14 of the base post 12 for connecting the base post 12 to the base level (BL) by inserting one or more fasteners through the plurality of holes and into the base level (BL).

4. The safety apparatus of claim 3, wherein the connector 32 comprises a prop plate 32 and the one or more fasteners 36, 38 comprise straight bolts or U-bolts.

5. The safety apparatus of claim 1, wherein each of the plurality of brace-slab connections (C) further comprises:
at least one brace connector, and
at least one fastener for connecting each respective one of the plurality of braces (24, 26, 28, 30) to the base level (BL).

6. The safety apparatus of claim 5, wherein one or more of the plurality of brace-slab connections (C) is a pivotable connection.

7. The safety apparatus of claim 6, wherein all of the plurality of brace-slab connections (C) is a pivotable connection.

8. The safety apparatus of claim 7, wherein each of the plurality of braces (24, 26, 28, 30) has a first pivot hole therethrough, proximate its first end (24a, 26a, 28a, 30a), wherein the at least one brace connector comprises a pair of brackets 40, 42, each of which is affixed to the base level (BL) and has a pivot hole therethrough which aligns with the first pivot hole of a respective one 26 of the plurality of braces (24, 26, 28, 30), when the respective one 26 of the plurality of braces (24, 26, 28, 30) is positioned between the pair of brackets 40, 42, and wherein the pivot fastener comprises a pivot bolt 64 for inserting through the aligned pivot holes of the pair of brackets 40, 42 and the first pivot hole of the respective brace 26.

9. The safety apparatus of claim 1, wherein each of the plurality of post-brace connections further comprises:
at least one connector, and
at least one fastener for connecting each respective one of the plurality of braces (24, 26, 28, 30) to the base post 12 proximate the second base post end 16.

10. The safety apparatus of claim 9, wherein one or more of the plurality of post-brace connections is a pivotable connection.

11. The safety apparatus of claim 10, wherein all of the plurality of post-brace connections is a pivotable connection.

12. The safety apparatus of claim 11, wherein each of the plurality of braces (24, 26, 28, 30) has a second pivot hole therethrough, proximate its second end (24b, 26b, 28b, 30b), wherein each of the plurality of post-brace connections further comprises a pair of connection plates 70a, 72a, each of which is affixed to, or formed integrally with, the base post 12 and extends in parallel with one another from the base post 12, proximate the second base post end 16,
wherein each of the pair of connection plates 70a, 72a has a pivot hole which aligns with the second pivot hole of a respective one 26 of the plurality of braces (24, 26, 28, 30) when the respective one 26 of the plurality of braces (24, 26, 28, 30) is positioned between the pair of connection plates 70a, 72a, and
wherein the pivot fastener comprises a pivot bolt 78a for inserting through the aligned pivot holes of the pair of connection plates 70a, 72a and the second pivot hole of the respective brace 26.

13. The safety apparatus of claim 12, wherein each of the plurality of braces (24, 26, 28, 30) includes first and second spacer plates 74a, 76a affixed on either side of its second end (24b, 26b, 28b, 30b), respectively, wherein each of the first and second spacer plates 74a, 76a has a pivot hole which aligns with the second pivot hole of the respective one 26 of the plurality of braces (24, 26, 28, 30) when the respective one 26 of the plurality of braces (24, 26, 28, 30) is positioned between the pair of connection plates 70a, 72a.

14. The safety apparatus of claim 1, wherein the attachment mechanism 84 comprises an anchor element adapted to connect to a tethering element which is attached to the worker.

15. The safety apparatus of claim 14, wherein a fall protection assembly comprises a harness worn by the worker and a tethering element having one end connected to the harness and an opposite end which is connected to the anchor element of the attachment mechanism 84.

16. The safety apparatus of claim 14, wherein the second mast end 22 is threaded and the attachment mechanism 84 includes a first half coupler 86 adapted to securely receive the threaded second end 22 of the mast 18 therein, the first half coupler 86 having a plate 88 affixed thereto and the anchor element is an anchor loop 88 affixed to the plate 88 and having a hole 92 to receive the tethering element or to couple with a device attached to a tethering element.

17. A safety apparatus which provides or enhances fall protection for a worker occupying a working level (WL) of a multiple level structure which also has a base level (BL) which is immediately below the working level (WL),
wherein the worker is wearing a fall protection assembly comprising a harness and a tethering element having one end connected to the harness and an opposite free end,
the safety apparatus comprising:
a base post 12 having:
a first base post end 14 connected to the base level (BL) of the multiple level structure to form a post-slab connection (B), and
a second base post end 16 opposite the first base post end 14; and
a mast 18 connected to the base post 12 and extending through an opening through the working level (WL) of the multiple level structure, the mast having:
a first mast end 20 which is connected to the second base post end 16 to form a post-mast connection (H) positioned between the base level (BL) and the working level (WL), and
a second mast end 22 opposite the first mast end 20 and positioned above the working level (WL);
a plurality of braces (24, 26, 28, 30), each of which has:
a first end (24a, 26a, 28a, 30a) connected to the base level (BL) of the multiple level structure to form a plurality of brace-slab connections (C), respectively, and a second end (24b, 26b, 28b, 30b) opposite its respective first end (24a, 26a, 28a, 30a), the second end of each of the plurality of braces (245, 26, 28, 30) being connected to the base post 12, proximate the second base post end 16, to form a plurality of post-brace connections (D); and
an attachment mechanism 84 affixed to, or formed integrally with, the second mast end 22, wherein the free end of the tethering element of the fall protection assembly worn by the worker is attached to the attachment mechanism.
